(19) United States
(12) Patent Application Publication
(10) Pub. No.: US 2006/0023816 A1
(43) Pub. Date: Feb. 2, 2006

(54) Sliding-window decoder with prolog-windows having flexibel sizes

(76) Inventors: Andries Pieter Hekstra, Eindhoven (NL); Johannus Theodorus Matheus Hubertus Dielissen, Eindhoven (NL); Josephus Antonius Huisken, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,936

(22) PCT Filed: Sep. 22, 2003
(86) PCT No.: PCT/IB03/04200

§ 371 Date: Apr. 19, 2005

(30) Foreign Application Priority Data
Oct. 23, 2002 (EP) 02079419.4

(51) Int. Cl. H04L 27/06

(52) U.S. Cl. 375/340

(57) ABSTRACT

Sliding-window decoders with processor-systems (1) for decoding streams of symbols run prolog deriving processes (23) for deriving initial parameters for prolog-windows, and run main deriving processes (24) for deriving main parameters for main-windows thereby using initial conditions defined by said initial parameters. By introducing defining processes (22) for defining the prolog-windows having a flexible number of symbols, a flexible size, dependently upon the needed quality of the initial condition, the prolog-window can be made larger/smaller (initial condition with higher/lower quality). As a result, the efficiency is improved, as a consequence of the average overlap between prolog-windows of a certain main-window and a neighboring main-window being reduced. Preferably, per main-window, the prolog-windows get increasing sizes. Based upon the insight of initial conditions needing to have flexible qualities, the basic idea introduces flexible sizes for prolog-windows. Sizes which grow per iteration make the sliding-window decoders even more advantageous.

The invention relates to a sliding-window decoder for decoding at least one block of symbols and comprising a processor-system for processing main-windows each comprising one or more symbols and for processing prolog-windows each comprising one or more symbols.

The invention also relates to a system comprising an encoder for encoding at least one block of symbols and comprising a sliding-window decoder,
and to a processor-system for use in a sliding-window decoder for decoding at least one block of symbols,
and to a method for sliding-window decoding at least one block of symbols by processing main-windows each comprising one or more symbols and by processing prolog-windows each comprising one or more symbols,
and to a processor program product to be run via a processor-system for use in a sliding-window decoder for decoding at least one block of symbols.

Such a sliding-window decoder forms for example part of a mobile terminal, with a base station or a network node for example comprising the encoder.

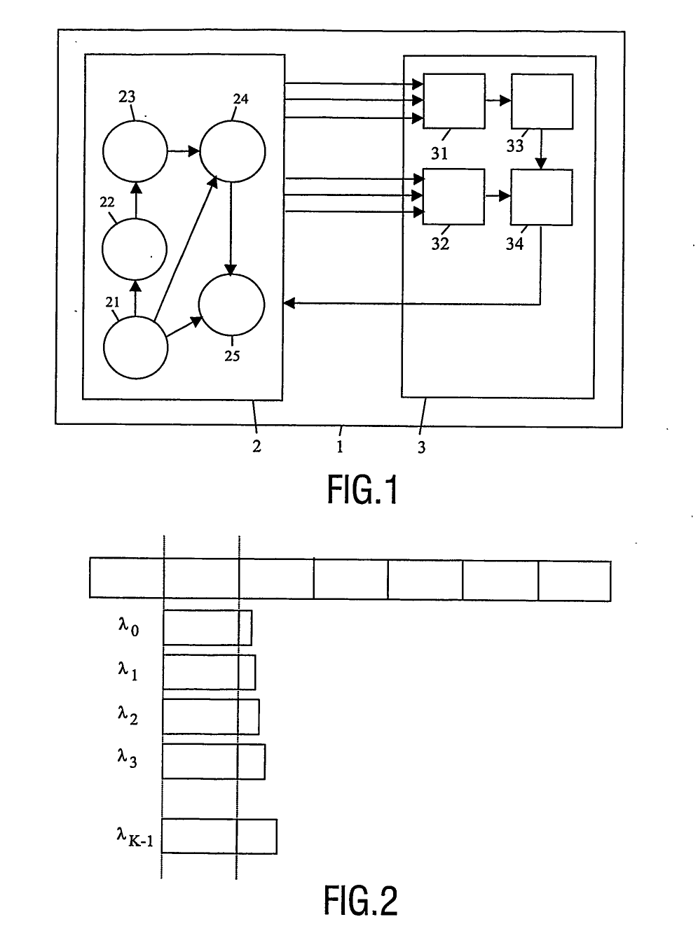

A prior art sliding-window decoder is known from U.S. 2001/0046269 A1, which discloses a sliding-window decoder for decoding at least one block of symbols and comprising a processor-system as shown in its FIGS. 1 and 2 comprising one or more processors, adder-trees, registers, MAX blocks, MAX registers, normalizers etc. as shown in its FIGS. 3, 4 and 5. Said processor-system runs prolog deriving processes for deriving initial parameters for prolog-windows, and runs main deriving processes for deriving main parameters (for example α's and β's) for main-windows thereby using initial conditions defined by said initial parameters (as described in its paragraph 0014) for filling/setting the registers, with these main-windows and prolog-windows being disclosed in its FIGS. 8 and 9. Said main parameters are processed for generating data estimate values (for example extrinsic data or a posteriori data), which indicate the most likely message symbols as encoded by an encoder and as sent from said encoder to said sliding-window decoder and their likelihoods.

The known sliding-window decoder is disadvantageous, inter alia, due to not being efficient: this known sliding-window decoder has parallellized forward-propagating processing (forward direction) and backward-propagating processing (backward direction), with the overlap of each of the prolog-windows of the iterations made for a certain main-window on the one hand and a neighboring main-window on the other hand causing many calculations to be done twice (any overlap causes calculations to be done twice).

It is an object of the invention, inter alia, of providing a sliding-window decoder which is more efficient.

It is a further object of the invention, inter alia, of providing a system which is more efficient.

It is a yet further object of the invention, inter alia, of providing a processor-system which is more efficient.

It is also an object of the invention, inter alia, of providing a method which is more efficient.

It is further also an object of the invention, inter alia, of providing a processor program product which is more efficient.

The sliding-window decoder according to the invention for decoding at least one block of symbols comprises a processor-system for processing main-windows each comprising one or more symbols and for processing prolog-windows each comprising one or more symbols, which processor-system comprises
at least one prolog deriving process for deriving at least one initial parameter for at least one prolog-window,
at least one main deriving process for deriving at least one main parameter for at least one main-window thereby using at least one initial condition defined by said at least one initial parameter,
at least one generating process for generating at least one data estimate value by processing said at least one main parameter, and
at least one defining process for defining at least a first prolog-window comprising a first number of symbols and at least a second prolog-window comprising a second number of symbols, which first number and second number are different from each other and unequal to zero.

By introducing one or more defining processes for defining prolog-windows comprising a flexible number of symbols, in addition to the deriving processes and the one or more generating processes, prolog-windows have been created which have got a flexible size. Dependently upon the needed quality of the initial condition, the prolog-window can be made larger (initial condition with higher quality) or smaller (initial condition with lower quality). As a result, the efficiency is improved, as a consequence of an average overlap being reduced.

When the quality of the data estimate values is judged as being high for certain iterations (for example due to little changes appearing in data estimate values for these certain (subsequent) iterations), it is interesting to use initial conditions having a high quality too (corresponding with prolog-windows having relatively large sizes and with relatively large overlaps), and vice versa.

It should be observed that the term “sliding-window” is not to be looked at too narrowly: in case of one processor doing all the work, the main-windows will be really sliding windows comprising neighboring main-windows, with a main-window overlapping all prolog-windows of all iterations made for a neighboring main-window; but in case of several processors cooperating, each processor may simultaneously process one or a series of main-windows. And, the term “data estimate value” is not to be looked at too narrowly and may comprise for example a most likely value per symbol (hard estimate) and/or one or more likelihoods for one or more values per symbol (soft estimate) etc. Further, the term “data estimate value” may comprise for example extrinsic data estimate values or data estimate values which could represent a decoded result (hard or soft).

It should further be observed that the invention is not limited to parallellized forward-propagating processing (forward direction) and backward-propagating processing (backward direction), the prolog-windows with flexible sizes can also be used in sliding-window decoders solely operating in just one of said directions.

It should be noted that many alternatives exist for the terms “prolog-window” and “main-window”: a main-window is also known as window, with a prolog-window then being defined as learning phase, upwarming phase, overlap, prolog etc.

It should further be noted that, when processing in the forward direction, the main-window starting with the last symbol received (not present in case of a continuous stream of symbols) will not have a prolog-window; the next main-window, due to prolog-windows usually being smaller than main-windows, will have a prolog-window (per iteration). And, when processing in the backward direction, the main-window starting with the first symbol received (not present in case of a continuous stream of symbols) will then not have a prolog-window; the next main-window, due to prolog-windows usually being smaller than main-windows, will have a prolog-window (per iteration).

A first embodiment of the sliding-window decoder according to the invention is defined by claim 2.

This sliding-window decoder has a number of prolog-windows per main-window with growing, increasing sizes. As a result, a main-window is iteratively processed based upon initial conditions having increasing qualities, and the sliding-window decoder operates with good efficiency (reduced average overlap). Said first, second and third iteration do not necessarily correspond with the first, the second and the third iteration, but correspond with three subsequent or non-subsequent iterations, with said second iteration chronologically following said first iteration in time, and with said third iteration chronologically following said second iteration in time.

A second embodiment of the system according to the invention is defined by claim 3.

This sliding-window decoder has a number of prolog-windows in subsequent iterations with the corresponding main-window being processed iteratively based upon subsequent initial conditions having increasing qualities. As a result, the sizes of the prolog-windows and the qualities of the initial conditions vary fluently, which improves the operating of said sliding-window decoder.

A third embodiment of the sliding-window decoder according to the invention is defined by claim 4.

This sliding-window decoder has a main-window processed iteratively based upon initial conditions having increasing qualities, with a starting prolog-window having a minimum size and therefore being based upon an initial condition having a minimum quality, and with a finishing prolog-window having a maximum size and therefore being based upon an initial condition having a maximum quality, and with an intermediate prolog-window having an intermediate size and therefore being based upon an initial condition having an intermediate quality. As a result, the sizes of the prolog-windows and the qualities of the initial conditions can be varied stepwise.

A fourth embodiment of the sliding-window decoder according to the invention is defined by claim 5.

Especially for sliding-window decoders based upon Maximum-A-Posteriori and/or Viterbi decoding processes, the flexible sizes of the prolog-windows and the flexible qualities of the initial conditions will bring great improvements.

The system according to the invention comprises an encoder for encoding at least one block of symbols and comprising a sliding-window decoder as defined by claim 1, wherein said encoder is a turbo encoder and/or wherein said sliding-window decoder is a turbo sliding-window decoder.

Especially for turbo encoding and/or turbo decoding, the flexible sizes of the prolog-windows and the flexible qualities of the initial conditions will bring great improvements.

Embodiments of the system according to the invention and of the processor-system according to the invention and of the method according to the invention and of the processor program product according to the invention correspond with the embodiments of the sliding-window decoder according to the invention.

The invention is based upon an insight, inter alia, that the initial conditions should have flexible qualities for improving the efficiency of the sliding-window decoder, and is based upon a basic idea, inter alia, that the size of the prolog-windows can be made flexible.

The invention solves the problem, inter alia, of providing a more efficient sliding-window decoder, and is advantageous, inter alia, in that, at increased efficiency, the performance of the sliding-window decoder has not decreased, and is further advantageous, inter alia, in that main-windows can now be made smaller, thereby allowing more parallel processes to be performed simultaneously.

These and other aspects of the invention will be apparent from and elucidated with reference to the embodiments(s) described hereinafter.

FIG. 1 illustrates in block diagram form a sliding-window decoder according to the invention comprising a processor-system according to the invention, and

FIG. 2 illustrates in timing diagram form main-windows and for one main-window the prolog-windows as generated by a processor-system according to the invention.

The sliding-window decoder shown in FIG. 1 comprises a processor-system according to the invention 1 having a controller 2 comprising one or more processors and a performer 3 comprising for example a β-block 31, a β-RAM 32, an α-block 33 and an extrinsic-block 34. As shown detailedly in U.S. 2001/0046269 A1, β-block 31 receives from controller 2 for example systematic data, parity data and a priori data and generates for example a β-vector which is supplied via β-RAM 32 to extrinsic-block 34, and α-block 33 receives from controller 2 for example systematic data, parity data and a priori data (but in reverse order compared to the β-situation) and generates for example an α-vector which is supplied to extrinsic-block 34. β-block 31 and α-block 33 and extrinsic-block 34 comprise for example adder-trees, registers, MAX blocks, MAX registers, normalizers etc.

As described detailedly in U.S. 2001/0046269 A1, in β-block 31 and α-block 33, said registers are set to initial conditions, the adder-trees sum the systematic data, parity data and a priori data according to a trellis used in the encoder, and results are stored in said registers. During a next stage, results from the address-trees are supplied to the MAX blocks and stored in the MAX registers. The unnormalized outputs are normalized by the normalizers etc.

According to the sliding-window approach, incoming data like an N-sized data block or a continuous stream of data is divided into smaller blocks called main-windows. These main-windows are decoded individually from each other. Due to initial conditions not being known for each main-window, prolog-windows (for the β-vectors and the α-vectors) are being used for getting good initial conditions. By starting the update of the α-vector at a point sufficiently inside the previous main-window and starting the update of the β-vector at a point sufficiently inside the next main-window, the decoder can forget that it has not started at the beginning or at the end of the stream of data and converge before it begins operating on the actual data in the main-windows.

The generation processes for the β-vectors and the α-vectors are divided into multiple stages, which stages are within iteration loops realized through feedback paths between said adder-trees, registers, MAX blocks, MAX registers, normalizers etc.

It should be noted that many alternatives exist for the terms “prolog-window” and “main-window”: a main-window is also known as window, with a prolog-window then being defined as learning phase, upwarming phase, overlap, prolog etc.

Controller 2 comprises a controlling process 21 for controlling other processes like for example a prolog deriving process 23 for deriving initial parameters for prolog-windows, a main deriving process 24 for deriving main parameters for main-windows thereby using initial conditions defined by initial parameters, a generating process 25 for generating data estimate values by processing said main parameters, and a defining process 22 for defining at least some of said prolog-windows having a flexible number of symbols.

As will be clear in view of the description of performer 3, at least parts of at least prolog deriving process 23 and main deriving process 24 and generating process 25 will take place in performer 3, but controlled by controlling process 21. About prolog deriving process 23, according to the decoder described in U.S. 2001/0046269 A1, the size of the prolog-window (the number of symbols in said prolog-window) is fixed.

According to the invention, as disclosed in FIG. 2, with λ for example being α or β and λ₀ corresponding with a main-window+prolog-window with a minimum size and λ₁ corresponding with a main-window+prolog-window with a one but smallest size etc. and λ_{K-1} corresponding with a main-window+prolog-window with a maximum size, defining process 22 for defining at least some of said prolog-windows having a flexible number of symbols has been introduced. Dependently upon the needed quality of the initial conditions, the prolog-windows can be made larger (higher quality initial condition) or smaller (lower quality initial condition). As a result, the efficiency of the decoder has been improved, as a consequence of an overlap between the prolog-window for a certain main-window and the neighboring main-window (the next main-window for β-vectors; the previous main-window for α-vectors) now being reduced (any one of these overlaps cause calculations to be done twice).

When the quality of the data estimate values is judged as being high for certain iterations, it is interesting to use initial conditions having a high quality too, and vice versa. To be able to detect the quality required for said initial conditions, controller 2 may be provided with a detecting process for detecting said converging and/or said systematic data, parity data and/or a priori data, and/or the development of the α-vectors and the β-vectors etc. More particularly, said detecting process may detect for example changes appearing in data estimate values for these certain (subsequent) iterations etc.

Preferably, a number of prolog-windows per main-window get growing, increasing sizes. As a result, a main-window is iteratively processed based upon initial conditions having increasing qualities, and the sliding-window decoder operates with good efficiency (reduced average overlap). Said first, second and third iteration do not necessarily correspond with the first, the second and the third iteration, but correspond with three subsequent or non-subsequent iterations, with said second iteration chronologically following said first iteration in time, and with said third iteration chronologically following said second iteration in time (at least sometimes, for example for lack of knowledge of the quality of the data estimate values, per main-window, initial conditions during earlier iterations are of less importance that initial conditions during later iterations).

By giving a number of prolog-windows in subsequent iterations increasing sizes, the corresponding main-window is processed iteratively based upon subsequent initial conditions having increasing qualities. As a result, the sizes of the prolog-windows and the qualities of the initial conditions vary fluently, which improves the operating of said sliding-window decoder.

By introducing a main-window processed iteratively based upon initial conditions having increasing qualities, with a starting prolog-window having a minimum size and therefore being based upon an initial condition having a minimum quality, and with a finishing prolog-window having a maximum size and therefore being based upon an initial condition having a maximum quality, and with an intermediate prolog-window having an intermediate size and therefore being based upon an initial condition having an intermediate quality, as a result, the sizes of the prolog-windows and the qualities of the initial conditions can be varied stepwise.

It should be noted that, when processing in the forward direction, the main-window starting with the last symbol received (not present in case of a continuous stream of symbols) will not have a prolog-window; the next main-window, due to prolog-windows usually being smaller than main-windows, will have a prolog-window (per iteration). And, when processing in the backward direction, the main-window starting with the first symbol received (not present in case of a continuous stream of symbols) will then not have a prolog-window; the next main-window, due to prolog-windows usually being smaller than main-windows, will have a prolog-window (per iteration).

The expression “for” in for example “for deriving” and “for defining” etc. does not exclude that other functions are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprises/included as well. The terms “a” and “an” do not exclude the possible presence of one or more pluralities. Symbols can be bits, or can have more than two values.

The invention is based upon an insight, inter alia, that the initial conditions should have flexible qualities for improving the efficiency of the sliding-window decoder, and is based upon a basic idea, inter alia, that the size of the prolog-windows can be made flexible.

The invention solves the problem, inter alia, of providing a more efficient sliding-window decoder, and is advantageous, inter alia, in that, at increased efficiency, the performance of the sliding-window decoder has not decreased, and is further advantageous, inter alia, in that main-windows can now be made smaller, thereby allowing more parallel processes to be performed simultaneously.

1. A sliding-window decoder for decoding at least one block of symbols and comprising a processor-system for processing main-windows each comprising one or more symbols and for processing prolog-windows each comprising one or more symbols, which processor-system comprises:
at least one prolog deriving process for deriving at least one initial parameter for at least one prolog-window,
at least one main deriving process for deriving at least one main parameter for at least one main-window thereby using at least one initial condition defined by said at least one initial parameter, and
at least one generating process for generating at least one data estimate value by processing said at least one main parameter,
wherein said processor-system comprises:
at least one defining process for defining at least a first prolog-window comprising a first number of symbols and at least a second prolog-window comprising a second number of symbols, which first number and second number are different from each other and unequal to zero.

2. The sliding-window decoder according to claim 1, wherein said defining process further defines at least a third prolog-window comprising a third number of symbols, with said first, second and third prolog-windows neighboring the same main-window in a first, second and third iteration, and with said first number being smaller than said second number and with said second number being smaller than said third number.

3. The sliding-window decoder according to claim 2, wherein said first, second and third prolog-windows are prolog-windows in subsequent iterations in a forward/backward direction with said first, second and third prolog-windows being situated before said main-window in the forward/backward direction.

4. The sliding-window decoder according to claim 2, wherein said first number has got a minimum value and said third number has got a maximum value and said second number has got an intermediate value.

5. The sliding-window decoder according to claim 5, wherein said sliding-window decoder is Maximum-A-Posteriori-based and/or Viterbi-based.

6. A system comprising an encoder for encoding at least one block of symbols and comprising a sliding-window decoder as defined by claim 1, wherein said encoder is a turbo encoder and/or wherein said sliding-window decoder is a turbo sliding-window decoder.

7. A processor-system for use in a sliding-window decoder for decoding at least one block of symbols and comprising said processor-system for processing main-windows each comprising one or more symbols and for processing prolog-windows each comprising one or more symbols, which processor-system comprises
at least one prolog deriving process for deriving at least one initial parameter for at least one prolog-window, and
at least one main deriving process for deriving at least one main parameter for at least one main-window thereby using at least one initial condition defined by said at least one initial parameter, and
wherein said processor-system comprises:
at least one defining process for defining at least a first prolog-window comprising a first number of symbols and at least a second prolog-window comprising a second number of symbols, which first number and second number are different from each other and unequal to zero.

8. The processor-system according to claim 7, wherein said defining process further defines at least a third prolog-window comprising a third number of symbols, with said first, second and third prolog-windows neighboring the same main-window in a first, second and third iteration, and with said first number being smaller than said second number and with said second number being smaller than said third number.

9. A method for sliding-window decoding at least one block of symbols by processing main-windows each comprising one or more symbols and by processing prolog-windows each comprising one or more symbols, which method comprises the steps of:
deriving, via at least one prolog deriving process, at least one initial parameter for at least one prolog-window,
deriving, via at least one main deriving process, at least one main parameter for at least one main-window thereby using at least one initial condition defined by said at least one initial parameter, and
generating, via at least one generating process, at least one data estimate value by processing said at least one main parameter,
wherein said method comprises the step of:
defining, via at least one defining process, at least a first prolog-window comprising a first number of symbols and at least a second prolog-window comprising a second number of symbols, which first number and second number are different from each other and unequal to zero.

10. A processor program product to be run via a processor-system for use in a sliding-window decoder for decoding at least one block of symbols and comprising said processor-system for processing main-windows each comprising one or more symbols and for processing prolog-windows each comprising one or more symbols, which processor program product comprises
at least one prolog deriving function for deriving at least one initial parameter for at least one prolog-window, and
at least one main deriving function for deriving at least one main parameter for at least one main-window thereby using at least one initial condition defined by said at least one initial parameter,
wherein said processor program product comprises:
at least one defining function for defining at least a first prolog-window comprising a first number of symbols and at least a second prolog-window comprising a second number of symbols, which first number and second number are different from each other and unequal to zero.
